(19) United States
(12) Patent Application Publication
(10) Pub. No.: US 2026/0156565 A1
(43) Pub. Date: Jun. 4, 2026

(54) MOBILITY MANAGEMENT BASED ON CONTROL CHANNEL ELEMENT AGGREGATION

(71) Applicant: T-MOBILE INNOVATIONS LLC, Overland Park, KS (US)

(72) Inventor: Jasinder P. SINGH, Olathe, KS (US)

(21) Appl. No.: 18/967,967

(22) Filed: Dec. 4, 2024

(51) Int. Cl. H04W 48/20

(52) U.S. Cl. CPC H04W 48/20

(57) ABSTRACT

Methods and systems provided herein provide for dynamic mobility management of wireless devices based on CCE aggregation level use. Methods provided herein determine a percentage of wireless devices in a cell utilizing a selected elevated control channel elements (CCE) aggregation level for receiving control information and compare percentage to a predetermined threshold. Methods provided herein further determine that the percentage meets or exceeds the predetermined threshold and dynamically relax a handover threshold based on the determination that the percentage meets or exceeds the predetermined threshold.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G new radio (NR) and millimeter wave (mm-wave) networks, as well as 4G long-term evolution (LTE) access nodes and older legacy protocols.

In these networks, control signals can be delivered from an access node to wireless devices over the physical downlink control channel (PDCCH). The control signals may include downlink control information (DCI), such as signals related to paging, traffic resource allocation, power control, etc. The physical resources designed to transmit DCI are referred to as the control resource set (CORESET). The CORESET includes multiple control channel elements (CCEs). One CCE may consume six physical resource blocks (PRBs). Further, one CCE includes six resource element groups (REGs) and one REG includes twelve resource elements.

During the evolution of newer wireless RATs, the concept of CCE aggregation has evolved in order to ensure that control signals reach wireless device users over the PDCCH. CCE aggregation is utilized for wireless devices with poor radio conditions, such as, for example, wireless devices located at a cell edge. The higher the CCE aggregation level, the more times the control information is sent in order to increase the probability that wireless devices in areas with poor radio conditions will receive the control information. For example, if the aggregation level is sixteen, the network sends the control information sixteen times in order to increase the probability that the wireless device will receive the control information.

However, with increased aggregation levels, although the probability that a wireless device in poor radio conditions will receive control signals is increased, the number of wireless devices that can be served in a cell decreases. For example, with twenty CCEs, a cell can serve twenty wireless devices when the CCEs are not aggregated. However, if the cell utilizes CCE aggregation level eight, for example, it can only serve two users. Accordingly, a solution is needed for utilizing CCE aggregation in a manner that will both ensure control signal reception and the ability to serve a requisite number of wireless devices.

### OVERVIEW

Exemplary embodiments provided herein include a method, system, access node, processing node, and/or non-transitory computer-readable medium for mobility management based on CCE aggregation. In one exemplary embodiment, a method is provided. The method determines a percentage of wireless devices in a cell utilizing a selected elevated CCE aggregation level for receiving control information. The method further compares the percentage to a predetermined threshold and determines that the percentage meets or exceeds the predetermined threshold. Further, the method includes dynamically relaxing a handover threshold based on the determination that the percentage meets or exceeds the predetermined threshold.

Embodiments disclosed herein further include a system for performing mobility management based on CCE aggregation levels. The system includes a memory storing data and instructions and a processor executing the stored instructions to perform multiple operations. The operations include determining a percentage of wireless devices in a cell utilizing a selected elevated control CCE aggregation level and comparing the percentage to a predetermined threshold. The operations additionally include dynamically relaxing a handover threshold in response to the percentage meeting or exceeding the predetermined threshold to trigger a handover of wireless devices experiencing a signal strength below a predetermined signal strength threshold.

In a further embodiment, an access node is provided for performing mobility management based on CCE aggregation levels. An access node includes wireless communication components for communication with wireless devices and a memory storing data and instructions. The access node additionally includes a processor executing the stored instructions based on communications with the wireless devices to perform multiple operations. The operations include determining a percentage of the wireless devices in communication with the access node utilizing a selected elevated CCE aggregation level for receiving control information and comparing the percentage to a predetermined threshold. The operations further include determining that the percentage meets or exceeds the predetermined threshold and dynamically relaxing a handover threshold based on the determination that the percentage meets or exceeds the predetermined threshold.

Further embodiments include processing nodes and non-transitory computer readable mediums performing the operations described above and similar operations as described herein.

### BRIEF DESCRIPTION OF THE DRAWINGS

FIG. 1 depicts an exemplary environment for a dynamic mobility management system in accordance with an embodiment.

FIG. 2 depicts a dynamic mobility management system in accordance with an embodiment.

FIG. 3 depicts an access node in accordance with an embodiment.

FIG. 4 depicts an exemplary method for performing dynamic mobility management in accordance with an embodiment.

FIG. 5 depicts a further exemplary method for performing dynamic mobility management in accordance with an embodiment.

FIG. 6 depicts a further exemplary method for performing dynamic mobility management in accordance with an embodiment.

### DETAILED DESCRIPTION

In embodiments disclosed herein, functionality for dynamically managing mobility of wireless devices in a network environment allowing control channel element (CCE) aggregation is disclosed. CCE aggregation was established to ensure that control signals are able to reach wireless devices experiencing poor radio conditions. Depending on the aggregation level, the control signals are transmitted a predetermined multiple number of times in order to increase the probability of reception by the wireless devices.

The physical resources designed to transmit downlink control information (DCI) are referred to as the control resource set (CORESET). The CORESET includes multiple CCEs. For the purposes of definition, it should be understood that one CCE encompasses six resource element groups (REGs) and one REG includes twelve resource elements (REs). For example, an aggregation level of two means that the PDCCH carrier will be made up of two CCEs including twelve REGs or one hundred forty four REs. The aggregation level is configured by the network and may be communicated to the wireless device via radio resource control (RRC) signaling messages. The wireless devices then monitors the PDCCH carrier for download control information (DCI) transmissions.

CCE aggregation was defined in order to support wireless devices in poor radio conditions, such as at a cell edge or in obstructed areas. The aggregation level is defined as the number of consecutive CCEs required to carry one PDCCH. When a wireless device has satisfactory radio conditions, one CCE can be used to send control information. However, when wireless devices are experiencing radio conditions that are unsatisfactory, CCEs can be aggregated to send control information. When two CCEs are aggregated, the control information is transmitted two times. When four CCEs are aggregated, the control information is sent four times. Similarly, eight CCEs or sixteen CCEs may be aggregated to send the control information eight or sixteen times in order to increase the probability that the wireless device can decode the control information. The CCE aggregation Level indicates how many CCEs are allocated for a PDCCH. The CCE aggregation level and the number of allocated CCEs is defined in following table 1:

TABLE 1

| Aggregation Level | Number of CCEs |
|---|---|
| 1 | 1 |
| 2 | 2 |
| 4 | 4 |
| 8 | 8 |
| 16 | 16 |

As further explanation, as the aggregation level increases, more resources are consumed as evidenced by the table below. As noted above, each CCE includes six REGs and the size of one REG is twelve resource elements (REs). The total number of available REs is calculated by multiplying 12 subcarriers by one symbol by the number of REGs at the aggregation level. The total number of available PDCCH RE is calculated by subtracting the number of REs used for the demodulation reference signal (DMRS) from the total number of REs. Finally, the total number of available bits for the aggregation level is calculated by multiplying the available PDCCH RE by two.

TABLE 2

| Aggregation | | | Available | |
|---|---|---|---|---|
| Level | CCEs | Available REs | PDCCH REs | Available bits |
| 1 | 1 | 72 | 54 | 108 |
| 2 | 2 | 144 | 108 | 216 |
| 4 | 4 | 288 | 216 | 432 |
| 8 | 8 | 576 | 432 | 864 |
| 16 | 16 | 1152 | 864 | 1728 |

Increased CCE aggregation limits the PDCCH capacity to send control information by limiting the number of wireless devices that can be served. Further, because the capacity of a cell is also dependent on bandwidth, the use of CCE aggregation can more adversely impact the capacity of a cell with limited bandwidth capability to serve wireless devices. For example, if a PDCHH includes twenty CCEs, it can serve twenty wireless devices. However, the aggregation of the CCEs can drastically decrease the number of wireless devices served. For example, if two wireless devices are utilizing aggregation level eight, this consumes sixteen CCEs for these two devices, with only four remaining for additional wireless devices.

Accordingly, embodiments provided herein propose to dynamically adjust a handover threshold of the serving cell based on the use of CCE aggregation in the serving cell as well as the available bandwidth. The adjusted handover threshold may be an intra band and/or inter band handover threshold. More specifically, when a threshold number or percentage of wireless devices in a cell are utilizing a selected level of CCE aggregation, systems and methods herein dynamically relax the handover threshold such that wireless devices experiencing poor radio conditions may be handed over to an adjacent cell site or to the capacity layer from the coverage layer.

For example, in one scenario, the threshold percentage may be set to fifty percent and the selected CCE aggregation level may be eight CCE with a 20 MHz bandwidth. Accordingly, if fifty percent or more than fifty percent of the wireless devices are utilizing level eight CCE aggregation or higher, systems and methods disclosed herein will dynamically relax the handover threshold so that devices experiencing poor radio conditions will more quickly be handed over to a neighboring cell site. In embodiments disclosed herein, methods will trigger a handover of the wireless devices utilizing the eight CCE aggregation level or higher. Additionally, wireless devices experiencing radio conditions that have deteriorated below a pre-determined threshold may be handed over. Further, the above-described scenario could be bandwidth dependent. For example, if the available bandwidth is reduced from 20 MHz to 10 MHz, the selected aggregation level may be four CCE rather than eight CCE.

Further, if the serving cell is the highest priority cell of multiple cells and CCE aggregation above a predetermined threshold is present in the cell, systems and methods provided herein change the idle mode cell re-selection priority of wireless devices utilizing the threshold CCE aggregation level. The idle mode cell re-selection priority may be changed utilizing a radio resource control (RRC) release message or subscriber profile identifier (SPID). The idle mode re-selection priority may be valid for a pre-determined time period.

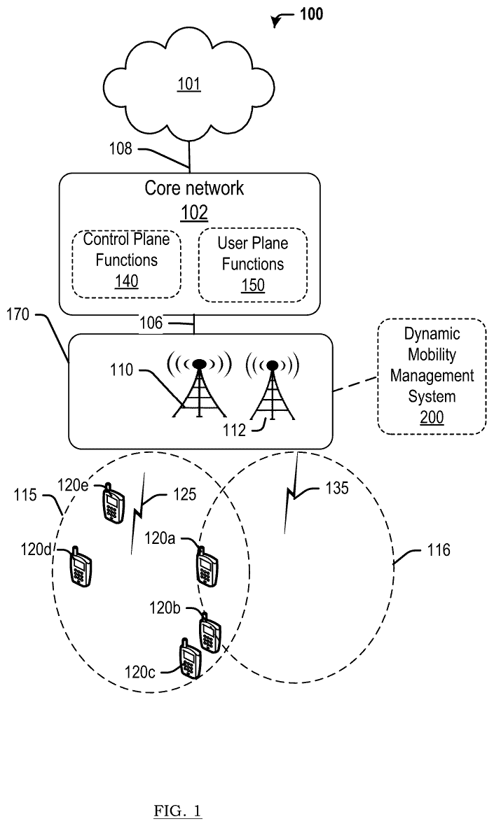

FIG. 1 depicts an exemplary environment 100 for implementing dynamic mobility management in a wireless network. In the displayed environment 100, a dynamic mobility management system 200 operates to monitor CCE aggregation levels of wireless devices 120a-120e in order to manage mobility of these devices between coverage areas 115 and 116. The wireless devices 120a-120e may be, for example, an enhanced mobile broadband (eMBB) device or any other type of wireless device capable of connecting with a wireless network.

Environment 100 comprises a communication network 101, core network 102, and a radio access network (RAN) 170 including at least two access nodes 110 and 112. Wireless devices 120a-120e communicate with the access node 110 via a communication link 125 and may further communicate with the access node 112 utilizing a communication link 135. The dynamic mobility management system 200 operates to facilitate handovers of wireless devices between the access nodes 110 and 112 based on CCE aggregation level and cell bandwidth.

Additionally, components not shown may include, for example, gateway node(s) controller nodes, and additional access nodes. For example, a wireless network may include one or more access nodes, such as base stations including evolved NodeBs (eNBs) or next generation NodeBs (gNBs) for providing wireless voice and data service to wireless devices in various coverage areas of the one or more access nodes. Various different iterations of radio access technologies (RATs) may be deployed within a single wireless network. Such heterogeneous wireless networks can include newer 5G and millimeter wave (mm-wave) networks, as well as 6G or 4G long-term evolution (LTE) access nodes.

Access nodes 110 and 112 can be any network node configured to provide communication between end-user wireless devices 120a-120e and communication network 101, including standard access nodes and/or short range, low power, small access nodes. For instance, access nodes 110 and 112 may include any standard access node, such as a macrocell access node, base transceiver station, a radio base station, an eNodeB device, an enhanced eNodeB device, a next generation NodeB device (gNBs) in 5G networks, or the like.

Further the access nodes 110 and 112 may include multiple co-located access nodes, such as a combination of eNodeBs and gNodeBs. Access nodes 110 and 112 can be small access nodes including a microcell access node, a picocell access node, a femtocell access node, or the like such as a home NodeB or a home eNodeB device. Moreover, it is noted that while access nodes 110 and 112 and wireless devices 120a-e are illustrated in FIG. 1, any number of access nodes and wireless devices can be implemented within environment 100.

As further described herein, by utilizing antennas, access nodes 110, 112 can deploy communication links 125, 135 using one or more frequency bands over one or more coverage areas 115, 116. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

The exemplary operating environment 100 may further include the dynamic mobility management system 200, which is illustrated as operating in conjunction with the RAN 170. In embodiments described herein, the mobility management system 200 is incorporated in the RAN 170, but may also be distributed and include components at the access node 110 cooperating with the components of the wireless devices 120a-e.

The dynamic mobility management system 200 monitors the CCE aggregation levels assigned by the access node 110 to the wireless devices 120a-120e. In embodiments provided herein, the dynamic mobility management system 200 monitors the number of wireless devices 120a-e utilizing a pre-selected CCE aggregation level. The pre-selected CCE aggregation level may be selected based on network characteristics such as bandwidth and signal strength. Further, the dynamic mobility management system 200 compares the number to a predetermined threshold number or compares the percentage of wireless devices using the pre-selected CCE aggregation level to a predetermined threshold percentage. When the number or percentage of wireless devices meets or exceeds the predetermined threshold number or percentage, the dynamic mobility management system 200 adjusts a handover threshold in order to relax the handover threshold and enable devices using the selected CCE aggregation level to be handed over to another access node or layer. The dynamic mobility management system 200 may also function to select the predetermined threshold number or percentage and also to select the pre-selected CCE aggregation level based on network characteristics.

Access nodes 110 and 112 can comprise a processor and associated circuitry to execute or direct the execution of computer-readable instructions to perform operations such as those further described herein. Briefly, access nodes 110 and 112 can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof. Further, access nodes 110 and 112 can receive instructions and other input at a user interface. Access nodes 110 and 112 are capable of communicating with the core network 102 as well as various additional nodes including gateway nodes, controller nodes, and other access nodes.

Further, the access nodes 110 and 112 may communicate with the dynamic mobility management system 200 and may partially or fully incorporate the dynamic mobility management system 200. Thus, the dynamic mobility management system 200 may collect data at the wireless devices 120a-e or at the access nodes 110, 112 and may perform processing in order to trigger a handover threshold adjustment by the access node 110.

Wireless devices 120a-120e may be any device, system, combination of devices, or other such communication platform capable of communicating wirelessly with access nodes 110, 112 using one or more frequency bands deployed therefrom. For example, the wireless devices 120a-120e may be, for example, an enhanced mobile broadband (eMBB) device. The wireless devices 120a-120e may be or include, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110 or 112. The wireless devices 120a-120e can be end-user wireless devices (e.g., user equipment (UEs) utilizing communication links 125, 135, which may operate based on 6G, 5G new radio (NR), 4G long term evolution (LTE), or any other suitable type of radio access technology (RAT).

The core network 102 includes core network functions and elements. The core network may be structured using a service-based architecture (SBA). The network functions and elements may be separated into user plane functions 150 and control plane functions 140. In an SBA architecture, service-based interfaces may be utilized between control-plane functions, while user-plane functions connect over point-to-point link. The user plane functions (UPF) 150 access a data network, such as network 101, and perform operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120a-120e and is responsible for handling connection and mobility management tasks. The SMF is primarily responsible for creating, updating, and removing sessions and managing session context. The UDM function provides services to other core functions, such as the AMF, SMF, and NEF. The UDM function may provide a stateful message store, holding information in local memory. The NSSF can be used by the AMF to assist with the selection of network slice instances that will serve a particular device. Further, the NEF provides a mechanism for securely exposing services and features of the core network.

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device. Wireless network protocols can comprise multimedia broadcast multicast service (MBMS), code division multiple access (CDMA), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106 and 108 can use various communication media, such as air, space, metal, optical fiber, or some other signal propagation path, including combinations thereof. Communication links 106 and 108 can be wired or wireless and use various communication protocols such as Internet, Internet protocol (IP), local-area network (LAN), optical networking, hybrid fiber coax (HFC), telephony, T1, or some other communication format. Communication links 106 and 108 can be a direct link or might include various equipment, intermediate components, systems, and networks. Communication links 106 and 108 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access nodes 110, 112 and communication network 101.

Further, the methods, systems, devices, networks, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

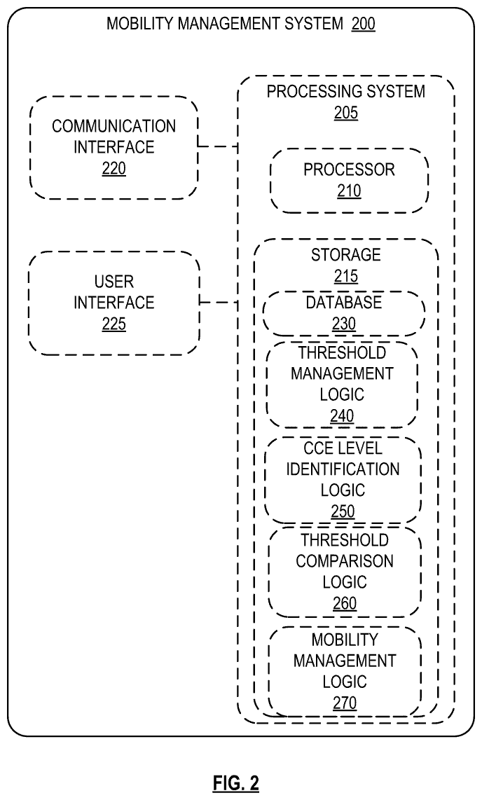

FIG. 2 illustrates an dynamic mobility management system 200 in accordance with embodiments described herein. The components described herein are merely exemplary as many different configurations for the dynamic mobility management system 200 may be implemented. The dynamic mobility management system 200 may be configured to perform the methods and operations disclosed herein to dynamically trigger adjustment of a handover threshold based on a threshold number or percentage of wireless devices utilizing a pre-selected CCE aggregation level. The handover threshold may be or include a threshold signal to noise plus interference ratio (SINR) or alternatively any other threshold indicative of signal strength or radio conditions.

Thus, the dynamic mobility management system 200 may communicate with the access node 110 and additionally or alternatively the wireless devices 120a-120e to determine a CCE aggregation level utilized by the wireless devices 120a-120e. Based on the gathered information, the dynamic mobility management system 200 may compare the gathered information to a predetermined threshold based on the pre-selected aggregation level. In the disclosed embodiments, the dynamic mobility management system 200 may be integrated with the access node 110, or may be an entirely separate component capable of communicating with the access node 110 and/or wireless devices 120a-120e . . . . Further, the components of the dynamic mobility management system 200 may be distributed so that one or more components are located within the RAN 170, and/or a separate processing node in communication with the RAN 170.

The dynamic mobility management system 200 may be configured for performing the operations described herein utilizing a processing system 205. Processing system 205 may include a processor 210 and a storage device 215. Storage device 215 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 210 to perform various methods disclosed herein. Software stored in storage device 215 may include computer programs, firmware, or other form of machine-readable instructions, including an operating system, utilities, drivers, network interfaces, applications, or other type of software. For example, software stored in storage device 215 may include a module for performing various operations described herein.

For example, threshold management logic 240 may be operable to select a predetermined threshold number or percentage of wireless devices using a pre-selected CCE aggregation level that will trigger an adjustment to the handover threshold. CCE aggregation level identification logic 250 may be operable to identify CCE aggregation levels utilized by the wireless devices and further may be operable to pre-select the CCE aggregation level based on network characteristics, such as, for example, bandwidth and signal strength. Thus, the CCE aggregation level identification logic may select the elevated CCE aggregation level based on an available bandwidth, such that the elevated CCE aggregation level increases with the available bandwidth in a cell.

Threshold comparison logic 260 is operable to compare the number or percentage of wireless devices utilizing the pre-selected CCE aggregation level to the predetermined threshold and determine whether the number or percentage meets or exceeds the predetermined threshold. Finally, mobility management logic 270 operates responsive to the threshold comparison logic 260 to adjust a handover threshold so that wireless devices utilizing the pre-selected CCE aggregation level and/or wireless devices having a signal to noise and interference ration (SINR) below a predetermined threshold level can be handed over to an alternative cell or layer. Further, the mobility management logic 270 may change an idle mode cell reselection priority of the wireless devices experiencing a signal strength below the predetermined signal strength threshold and/or of the wireless devices utilizing the selected CCE aggregation level. The mobility management logic 270 may change the cell reselection priority through a radio resource control (RRC) message or a subscriber profile identifier (SPID).

Further, the storage device 215 may include a database 230. The database 230 may store network information, a pre-selected CCE aggregation level, a predetermined threshold number or percentage, and/or a predetermined SINR threshold. To perform the above-described operations, the threshold management logic 240, the CCE level identification logic 250, the threshold comparison logic 260, and the mobility management logic 270 may be executed by the processor 210 to manage mobility of the wireless devices 120a-120e.

Processor 210 may be a microprocessor and may include hardware circuitry and/or embedded codes configured to retrieve and execute software stored in storage device 215. The dynamic mobility management system 200 further includes a communication interface 220 and a user interface 225. Communication interface 220 may be configured to enable the processing system 205 to communicate with other components, nodes, or devices in the wireless network.

Communication interface 220 may include hardware components, such as network communication ports, devices, routers, wires, antenna, transceivers, etc. User interface 225 may be configured to allow a user to provide input to the dynamic mobility management system 200 and receive data or information from other system components. User interface 225 may include hardware components, such as touch screens, buttons, displays, speakers, etc. The dynamic mobility management system 200 may further include other components such as a power management unit, a control interface unit, etc.

Accordingly, the dynamic mobility management system 200 executes instructions stored in storage device 215 to determine a percentage of wireless devices in a cell utilizing a selected elevated control channel elements (CCE) aggregation level and compare the percentage to a predetermined threshold. The dynamic mobility management system 200 further executes the instructions to dynamically relax a handover threshold in response to the percentage meeting or exceeding the predetermined threshold to trigger a handover of wireless devices experiencing a signal strength below a predetermined signal strength threshold and/or wireless devices utilizing the selected elevated CCE aggregation level. Dynamically relaxing the handover threshold may include relaxing an inter band handover threshold or an intra band handover threshold. Based on the wireless devices meeting the handover threshold, the system 200 may trigger a handover of the wireless devices utilizing the selected elevated CCE aggregation level.

The location of the dynamic mobility management system 200 may depend upon the network architecture. As set forth above, the dynamic mobility management system 200 may be located in the RAN 170, in a separate processing node, or in multiple locations. Further, although shown as a single integrated system, the functions described herein may be separated and be disposed in separate locations.

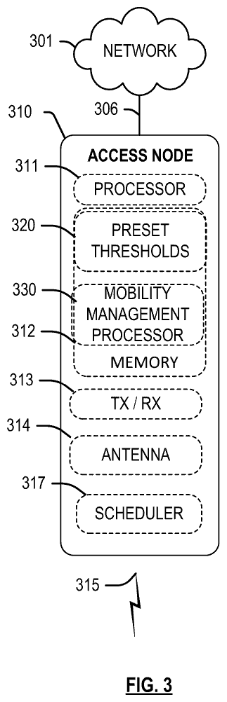

FIG. 3 depicts an exemplary access node 310. The access node 310 may be a more specific rendering of the access node 110 or 112. Access node 310 is configured as an access point for providing network services from network 301 to end-user wireless devices such as wireless devices 120a-120e. Access node 310 is illustrated as comprising a memory 312 for storing logical modules that perform operations described herein, a processor 311 for executing the logical modules, and a transceiver 313 for transmitting and receiving signals via one or more antennas 314. Wireless communication components include combinations of the antennas 314 and transceivers 313 configured to deploy wireless air interfaces. Further, the different sets of antennas can be used to implement various transmission modes or operating modes in each sector, including but not limited to multiple in multiple out (MIMO), carrier aggregations, and different duplexing modes including frequency division duplexing (FDD) and time division duplexing (TDD). Further, access node 310 may deploy different bearers for communication with the wireless devices 120a-120e, wherein the different bearers have different characteristics. The access node 310 is communicatively coupled to network 301 via communication interface 306, which may be any wired or wireless link as described above. Scheduler 317 may be provided for scheduling resources for the wireless devices 120a-120e. Wireless communication link 315 may facilitate communication with the wireless devices 120a-120e in both uplink and downlink directions.

In an exemplary embodiment, memory 312 includes pre-set thresholds 320, such as handover thresholds, signal strength thresholds, and the predetermined threshold of the number or percentage of wireless devices in a cell that can use the selected elevated CCE aggregation level. A mobility management processor 330 may be or include the dynamic mobility management system 200 or a portion of the dynamic mobility management system 200, and/or may operate cooperatively with the dynamic mobility management system 200. The mobility management processor 330 may be triggered by the use of the CCE aggregation levels for sending control information in the downlink. For example, when the dynamic mobility management processor 330 detects the use of CCE aggregation, it may track the number of wireless devices utilizing CCE aggregation or alternatively, the dynamic mobility management processor 330 may be notified by the dynamic mobility management system 200 that the number of wireless devices utilizing the selected elevated CCE aggregation level meets a threshold. The mobility management processor 330 may adjust a default handover threshold by relaxing the handover threshold. For example, the mobility management processor may adjust the SINR required to trigger a handover. Further, the mobility management processor 330 may change an idle mode cell reselection priority of the wireless devices experiencing a signal strength below a predetermined signal strength threshold. The mobility management processor 330 may change the cell reselection priority through a radio resource control (RRC) message or a subscriber profile identifier (SPID). The SPID determines the priority and preferences of a subscriber or device when connecting to different RATs or frequencies within a network and helps optimize network resource allocation and handover decisions.

Accordingly, embodiments disclosed herein include an access node 310 having wireless communication components for communication with wireless devices and a processor 311 executing the instructions stored in memory to perform multiple operations. The operations may include determining a percentage of the wireless devices in communication with the access node utilizing a selected elevated control channel element (CCE) aggregation level for receiving control information and comparing the percentage to a predetermined threshold. The operations further include determining that the percentage meets or exceeds the predetermined threshold and dynamically relaxing a handover threshold based on the determination that the percentage meets or exceeds the predetermined threshold. The handover threshold may be or include an inter band and/or an intra band handover threshold. Further, the access node 310 may select the elevated CCE aggregation level based on available bandwidth, such that the elevated CCE aggregation level increases with the available bandwidth.

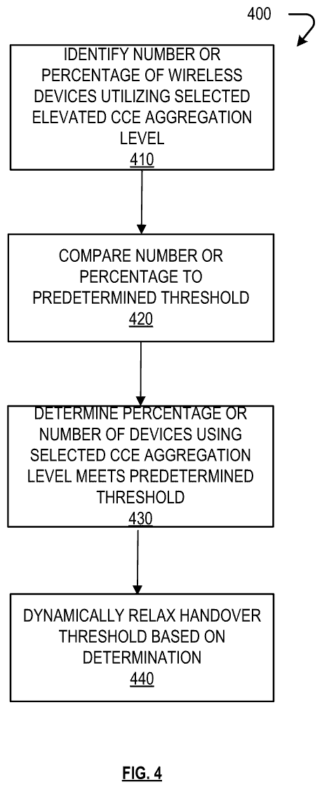

FIG. 4 illustrates a generalized exemplary method 400 for dynamic mobility management in accordance with embodiments provided herein using the dynamic mobility management system 200. Method 400 may be performed by a processor, for example, the processor 210 included in the dynamic mobility management system 200 or the processor 311 included in the access node 310 For discussion purposes, as an example, method 400 is described as being performed by the processor 210 of the dynamic mobility management system 200. However, it should be understood that the steps illustrated in FIG. 4 are performed in conjunction with the mobility management processor 330 and the processor 210 may, in fact, be incorporated in the access node 310.

Method 400 starts in step 410, in which the processor 210 identifies any of wireless devices 120a-120e in a cell utilizing a selected elevated CCE aggregation level for receiving control information from the access node 110. For example, with reference to FIG. 1, the processor 210 may determine that wireless devices 120a, 120b, and 120c, which are proximal to a boundary of coverage area 115, are utilizing CCE aggregation level eight, which is the pre-selected elevated CCE aggregation level.

In step 420, the processor 210 determines a percentage or a number of wireless devices in a cell utilizing a selected elevated CCE aggregation level for receiving control information. Accordingly, with reference to the example provided above, three out of five or 60% of the wireless devices 120a-120e in the cell, are utilizing the selected elevated CCE aggregation level of eight.

In step 430, the processor 210 performs a comparison and determines that the percentage or number of wireless device utilizing the selected elevated CCE aggregation level meets or exceeds a predetermined threshold percentage or number. Thus, for example, the percentage of sixty percent meets or exceeds a pre-determined threshold percentage, which may, for example, be fifty percent. Alternatively, the processor 210 determines that three wireless devices meets a predetermined threshold number of wireless devices when the predetermined threshold number is two, for example.

In response to the determination in step 430, the processor 210 dynamically relaxes a handover threshold based on the determination in step 440. The handover threshold may be or include an intra band and/or an inter band threshold. The relaxing of the handover threshold may then trigger a handover of the wireless devices utilizing the selected elevated CCE aggregation level to another cell site or to another layer. Further, in some embodiments, the relaxation of the handover threshold may trigger the handover of other wireless devices. For example, the handover threshold may be a SINR threshold and wireless devices experiencing a SINR below the SINR threshold may be subject to handover.

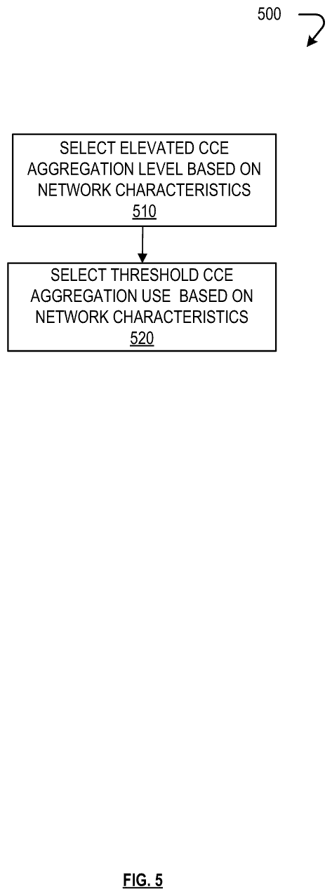

FIG. 5 depicts a further exemplary method 500 for dynamic mobility management based on CCE level using the dynamic mobility management system 200. Method 500 may be performed by a processor, for example, the processor 210 included in the dynamic mobility management system 200 or the processor 311 included in the access node 310 For discussion purposes, as an example, method 500 is described as being performed by the processor 210 of the dynamic mobility management system 200. However, it should be understood that the steps illustrated in FIG. 5 are performed in conjunction with the mobility management processor 330 and the processor 210 may, in fact, be incorporated in the access node 310.

In step 510, the processor 210 selects an elevated CCE aggregation level for monitoring based on network characteristics. For example, the processor 210 may select the elevated CCE aggregation level for monitoring based on available bandwidth, such the selected elevated CCE aggregation level increases with the available bandwidth. For example, with a bandwidth of 10 MHz, the selected elevated aggregation level may be CCE aggregation level four. However, with a bandwidth of 20 MHz, the selected elevated CCE aggregation level may be CCE aggregation level eight.

In step 520, the processor 210 may select threshold CCE aggregation use based on the network characteristics. For example, the processor 210 may select the usage threshold to be a pre-designated number of wireless devices based on typical network load. Alternatively, the processor 210 may select the predetermined threshold to be a threshold percentage of wireless devices based on typical network load and/or network bandwidth. Accordingly, the steps 510 and 520 set both the predetermined selected elevated CCE aggregation level and the threshold number or percentage of devices.

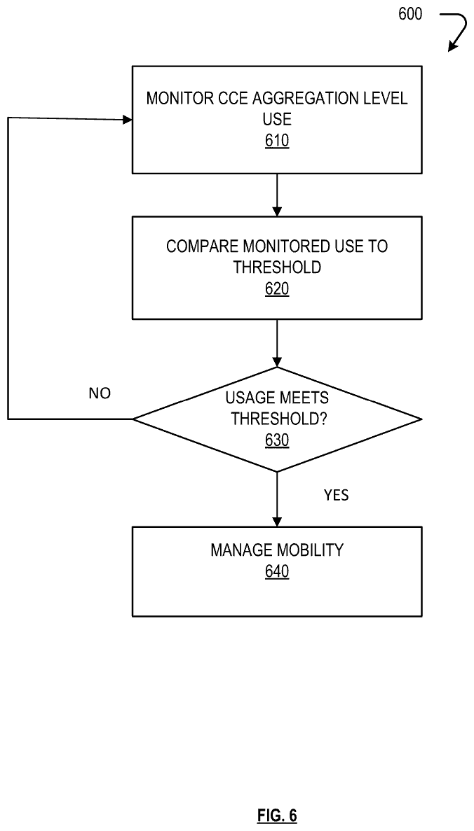

FIG. 6 depicts an additional exemplary method 600 for dynamic mobility management in accordance with embodiments disclosed herein. Method 600 may be performed by a processor, for example, the processor 210 included in the dynamic mobility management system 200 or the processor 311 included in the access node 310 For discussion purposes, as an example, method 600 is described as being performed by the processor 210 of the dynamic mobility management system 200. However, it should be understood that the steps illustrated in FIG. 6 are performed in conjunction with the mobility management processor 330 and the processor 210 may, in fact, be incorporated in the access node 310.

In step 610, the processor 210 may monitor CCE aggregation level use for the wireless devices within a coverage area. As set forth above, the processor 210 identifies any of wireless devices 120a-120e in a cell utilizing a selected elevated CCE aggregation level for receiving control information from the access node 110. For example, with reference to FIG. 1, the processor 210 may determine that wireless devices 120a, 120b, and 120c, which are proximal to a boundary of coverage area 115, are utilizing CCE aggregation level eight, which is the pre-selected elevated CCE aggregation level.

In step 620, the processor 210 compares the monitored use of the selected elevated CCE aggregation level to the predetermined usage threshold as explained above. If, at step 630, the usage does not meet the threshold, the processor 210 simply returns to monitoring. However, if the usage does meet the threshold in step 630, the processor 210 manages mobility in step 640. In one scenario, the processor 210 dynamically relaxes a handover threshold based on the determination in step 440. The handover threshold may be or include an intra band and/or an inter band threshold. The relaxing of the handover threshold may then trigger a handover of the wireless devices utilizing the selected elevated CCE aggregation level to another cell site or to another layer. Typically, the wireless devices utilizing the selected elevated CCE aggregation level are experiencing deteriorating radio conditions.

Further, in some embodiments, the relaxation of the handover threshold may trigger the handover of other wireless devices. For example, the handover threshold may be a SINR threshold and wireless devices experiencing a SINR below the SINR threshold may be subject to handover. However, often the wireless devices experiencing a signal strength below the predetermined signal strength threshold are the wireless devices utilizing the selected elevated CCE aggregation level.

Management of mobility in step 640 may further include changing an idle mode cell reselection priority of the wireless devices experiencing a signal strength below a predetermined signal strength threshold. The processor 210 may trigger the alteration to the cell re-selection priority through an RRC message or a SPID.

Accordingly, as set forth above, embodiments providing for dynamic mobility management based on CCE aggregation use are disclosed. In some embodiments, methods 400, 500, and 600 may include additional steps or operations and additional network components. Furthermore, the methods may include steps shown in each of the other methods. Additionally, the order of steps shown is merely exemplary and the steps may be re-ordered as appropriate. As one of ordinary skill in the art would understand, the methods 400, 500, and 600 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
determining a percentage of wireless devices in a cell utilizing a selected elevated control channel element (CCE) aggregation level for receiving control information;
comparing the percentage to a predetermined threshold;
determining that the percentage meets or exceeds the predetermined threshold; and
dynamically relaxing a handover threshold based on the determination that the percentage meets or exceeds the predetermined threshold.

2. The method of claim 1, further comprising selecting the elevated CCE aggregation level based on an available bandwidth, such that the elevated CCE aggregation level increases with the available bandwidth.

3. The method of claim 1, wherein dynamically relaxing the handover threshold comprises relaxing an inter band handover threshold.

4. The method of claim 1, wherein dynamically relaxing the handover threshold comprises relaxing an intra band handover threshold.

5. The method of claim 1, further comprising triggering a handover of the wireless devices utilizing the selected elevated CCE aggregation level.

6. The method of claim 1, wherein the wireless devices utilizing the selected elevated CCE aggregation level are experiencing deteriorating radio conditions.

7. The method of claim 1, further comprising changing an idle mode cell reselection priority of the wireless devices experiencing a signal strength below a predetermined signal strength threshold.

8. The method of claim 7, wherein the cell reselection priority is changed through a radio resource control (RRC) message or a subscriber profile identifier (SPID).

9. The method of claim 7, wherein the wireless devices experiencing a signal strength below the predetermined signal strength threshold are the wireless devices utilizing the elevated CCE aggregation level.

10. A system comprising:
a memory storing data and instructions; and
a processor executing the stored instructions to perform operations including;
determining a percentage of wireless devices in a cell utilizing a selected elevated control channel element (CCE) aggregation level;
comparing the percentage to a predetermined threshold; and
dynamically relaxing a handover threshold in response to the percentage meeting or exceeding the predetermined threshold to trigger a handover of wireless devices experiencing a signal strength below a predetermined signal strength threshold.

11. The system of claim 10, the operations further comprising changing an idle mode cell reselection priority of the wireless devices experiencing a signal strength below the predetermined signal strength threshold.

12. The system of claim 11, wherein the cell reselection priority is changed through a radio resource control (RRC) message or a subscriber profile identifier (SPID).

13. The system of claim 10, further comprising selecting the elevated CCE aggregation level based on an available bandwidth, such that the elevated CCE aggregation level increases with the available bandwidth.

14. The system of claim 10, wherein dynamically relaxing the handover threshold comprises relaxing an inter band handover threshold or an intra band handover threshold.

15. The system of claim 10, the operations further comprising triggering a handover of the wireless devices utilizing the selected elevated CCE aggregation level.

16. An access node comprising:
wireless communication components for communication with wireless devices;
a memory storing data and instruction;
a processor executing the stored instructions based on communications with the wireless devices to perform operations including;
determining a percentage of the wireless devices in communication with the access node utilizing a selected elevated control channel element (CCE) aggregation level for receiving control information;
comparing the percentage to a predetermined threshold;
determining that the percentage meets or exceeds the predetermined threshold; and
dynamically relaxing a handover threshold based on the determination that the percentage meets or exceeds the predetermined threshold.

17. The access node of claim 16, further comprising selecting the elevated CCE aggregation level based on an available bandwidth, such that the elevated CCE aggregation level increases with the available bandwidth.

18. The access node of claim 16, wherein dynamically relaxing the handover threshold comprises relaxing an inter band handover threshold or an intra band handover threshold.

19. The access node of claim 16, the operations further comprising changing an idle mode cell reselection priority of the wireless devices experiencing a signal strength below a predetermined signal strength threshold.

20. The access node of claim 19, wherein the cell reselection priority is changed through a radio resource control (RRC) message or a subscriber profile identifier (SPID).
